(19) United States
(12) Patent Application Publication
(10) Pub. No.: US 2009/0210203 A1
(43) Pub. Date: Aug. 20, 2009

(54) Cell-planning method for wireless optical communication system

(75) Inventors: Eun-Tae Won, Seoul (KR); Dae-Seok Kim, Seoul (KR); Jong-Hoon Ann, Suwon-si (KR); Jae-Seung Son, Suwon-si (KR)

Correspondence Address: CHA & REITER, LLC, 210 ROUTE 4 EAST STE 103, PARAMUS, NJ, 07652, US

(73) Assignee: Samsung Electronics Co.,Ltd.

(21) Appl. No.: 12/378,294

(22) Filed: Feb. 13, 2009

(30) Foreign Application Priority Data
Feb. 15, 2008 (KR) 10-2008-0014162

(51) Int. Cl. G06F 17/10; G06G 7/62

(52) U.S. Cl. 703/2; 703/13; 398/118; 455/446

(57) ABSTRACT

A cell-planning method for a wireless optical communication system includes: implementing a target region for constructing a wireless optical communication system as a virtual space; disposing a virtual light source within the virtual space; checking a sequence number of a virtual light ray generated by the virtual light source; checking the number of intersection points occurring between the virtual light ray, the sequence number of which has been checked, and surfaces of virtual objects, and comparing the number of intersection points of the virtual light ray with an allowable number of intersection points; storing the virtual light ray when the number of intersection points of the virtual light ray is greater than the allowable number of intersection points; and comparing the sequence number of the virtual light ray with a set number of virtual light rays.

### CLAIM OF PRIORITY

This application claims the benefit under of an earlier patent application entitled “Cell-Planning Method for Wireless Optical Communication System,” filed in the Korean Intellectual Property Office on Feb. 15, 2008 and assigned Serial No. 2008-14162, the contents of which are hereby incorporated by reference.

### BACKGROUND OF THE INVENTION

1. Field of the Invention

The present invention relates to a wireless communication system, and more particularly to a cell-planning method for a wireless optical communication system.

2. Description of the Related Art

A wireless communication system uses a cell-planning to maximize the use of frequencies between base stations.

The cell-planning represents a pre-processing of simulating locations of a base station, antenna parameters, output power of the base station, the number of channels, and frequency arrangement, before the wireless communication system is actually implemented. It further considers various factors, which include costs, capacities, service coverages, grades of service, sound qualities, installations to be expanded in the future, and so on.

The cell-planning requires site survey, database construction, dimension simulation, and record of propagation measurement results. Various types of propagation prediction models, such as the Okmura model, the Hata model, the Longley-Rice model, etc. may be used.

However, since the cell-planning methods for the wireless communication system refers to a system construction using radio frequency, the cell-planning cannot be applied to a wireless system using light due to a large difference in frequency bandwidth.

Since radio frequency and light have different reflection and diffraction characteristics, there is a limitation in applying the conventional cell-planning method of a wireless communication system to a wireless optical communication system.

### SUMMARY OF THE INVENTION

Accordingly, the present invention has been made to solve the above-mentioned problems occurring in the prior art, and the present invention provides a cell-planning method applicable to a wireless optical communication system and its system employing the cell-planning method.

In accordance with one aspect of the present invention, a cell-planning method for a wireless optical communication system includes: (a) implementing a target region for constructing a wireless optical communication system as a virtual space; (b) disposing a virtual light source within the virtual space; (c) checking a sequence number of a virtual light ray generated by the virtual light source; (d) checking the number of intersection points occurring between the virtual light ray, the sequence number of which has been checked, and surfaces of virtual objects, and comparing the number of intersection points of the virtual light ray with an allowable number of intersection points; (e) storing the virtual light ray when the number of intersection points of the virtual light ray is greater than the allowable number of intersection points; and (f) comparing the sequence number of the virtual light ray with a set number of virtual light rays, and repeating (c) to (f) when the sequence number of the virtual light ray is less than the set number of virtual light rays.

### BRIEF DESCRIPTION OF THE DRAWINGS

The above and other aspects, features and advantages of the present invention will be more apparent from the following detailed description taken in conjunction with the accompanying drawings, in which:

FIG. 1 is a perspective view illustrating a virtual space;

FIGS. 2A to 2C are flowcharts explaining a cell-planning method for a wireless optical communication system according to an embodiment of the present invention;

FIGS. 3A to 3B are views explaining an adjustment of the positions of light sources; and

FIGS. 4A to 4C are views illustrating receivable ranges by virtual optical receivers.

### DETAILED DESCRIPTION OF THE INVENTION

Hereinafter, embodiments of the present invention will be described with reference to the accompanying drawings. For the purposes of clarity and simplicity, a detailed description of known functions and configurations incorporated herein will be omitted as it may make the subject matter of the present invention unclear.

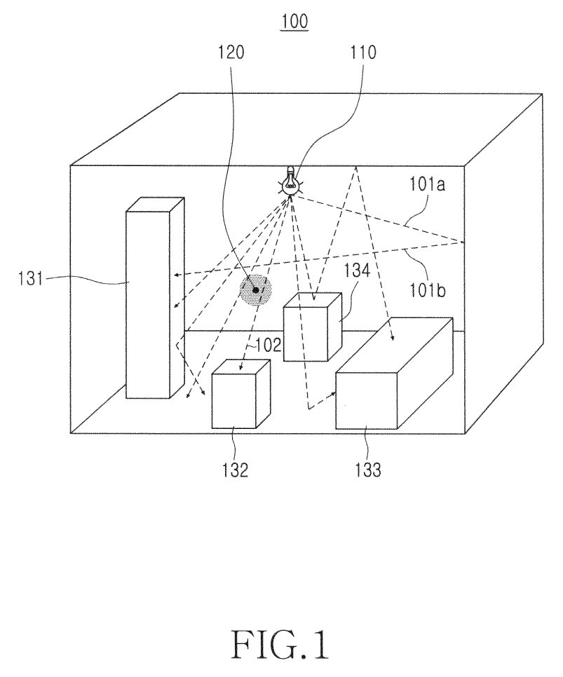

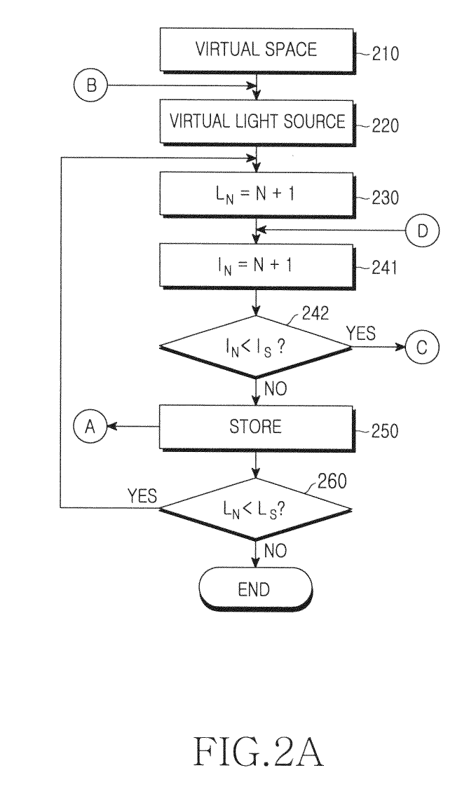

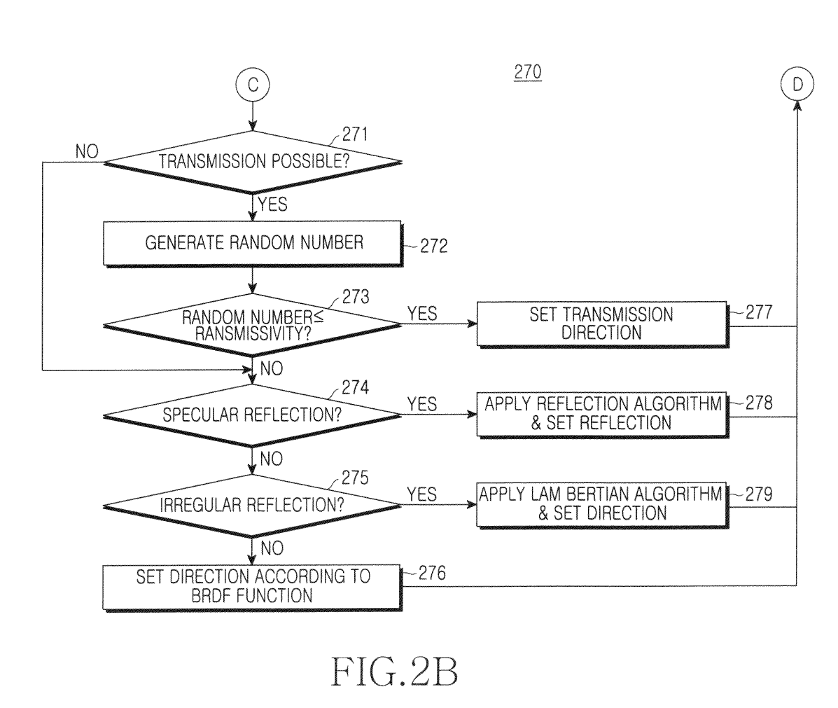

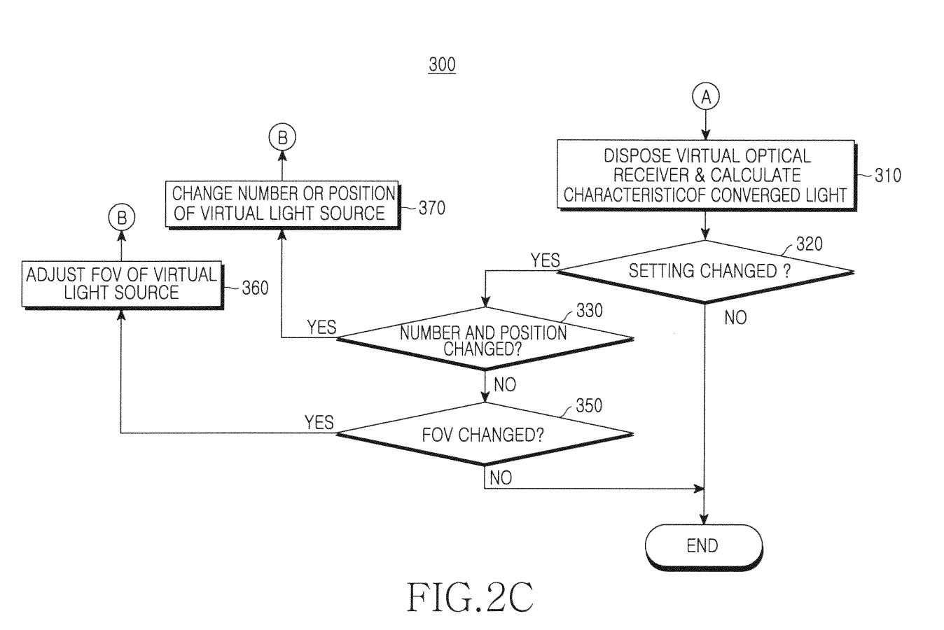

FIG. 2A is a flowchart illustrating a simulation process using a virtual light source within a virtual space shown in FIG. 1. As shown, a cell-planning method for a wireless optical communication system according to an embodiment of the present invention includes: (a) implementing a target region for constructing the wireless optical communication system as a virtual space (step 210); (b) disposing a virtual light source within the virtual space (step 220); (c) checking a sequence number of a virtual light ray generated by the virtual light source (step 230); (d) checking the number of intersection points occurring between the virtual light ray, the sequence number of which has been checked, and surfaces of virtual objects (step 241), and comparing the number of intersection points of the virtual light ray with an allowable number of intersection points (step 242); (e) storing the virtual light ray when the number of intersection points of the virtual light ray is greater than the allowable number of intersection points, i.e. in the case of “NO” in step 242 of FIG. 2A, (step 250); (f) comparing the sequence number L_{N} of the virtual light ray with a set number L_{S} of virtual light rays, and repeating steps (c) to (f) when the sequence number L_{N} of the virtual light ray is less than the set number L_{S} of virtual light rays, i.e. in the case of “YES” in step 260 of FIG. 2A, (step 260); (g) determining if a virtual object's surface on which an intersection point is made by the virtual light ray can be transmitted (step 271); (h) generating a random number (step 272) when the virtual object's surface can be transmitted, and comparing the generated random number with transmissivity (step 273); (i) determining if the virtual light ray is specularly-reflected from the virtual object surface when the random number is greater than the transmissivity, i.e. in the case of “NO” in step 273 of FIG. 2B, (step 274); and (g) determining if the virtual light ray is irregularly-reflected from the virtual object's surface on which the virtual light ray is incident when it is determined in step (i) that the virtual light ray is not specularly-reflected, in the case of “NO” in step 274 of FIG. 2B, (step 275).

In step 210 of implementing the virtual space, a region (e.g. an area, or a place) in which to construct a wireless optical communication system is implemented by computer programming, wherein the virtual space may be implemented as shown in FIG. 1.

Within the virtual space 100 of FIG. 1, a plurality of virtual objects 131 to 134 corresponding to buildings or objects in actual spaces may be placed, and a virtual light source 110 may be disposed at a position, corresponding to that of an actual optical transmitter, in the virtual space 100. Also, a virtual optical receiver 120 may be disposed at a position, corresponding to that of an actual optical receiver, in the virtual space 100. In this case, it is possible to calculate the characteristics of virtual light rays at various positions, where the virtual optical receiver is disposed, and to use a result of the calculation to establish the position of the virtual light source 110. The virtual light rays 101a, 101b, and 102 are incident on the virtual objects 131 to 134 within the virtual space 100, and then may be reflected from or transmitted through the virtual objects 131 to 134.

Step 230 of identifying the sequence number (which is numbered in regular sequence) of each virtual light ray 101a, 101b, and 102 generated by the virtual light source 110 may be performed by equation 1 below, and may be used to distinguish virtual light rays simulated by the virtual light source 110, and to terminate a cell-planning procedure when the number of times of the simulation exceeds a preset value.

L_{N}=N+1 (1)

In equation 1, “L_{N}” represents a virtual light ray, and “N” represents a sequence number assigned to the virtual light ray, wherein “N” is an integer starting from “0” and ending at a positive integer “n.”

For example, a first virtual light ray may be expressed as L₀, which has a sequence number of 1. A second virtual light ray may be expressed as L₁, which has a sequence number of 2. An n^{th} virtual light ray may be expressed as L_{N}, which has a sequence number of n+1.

Step (d), i.e. steps 241 and 242, is performed to reflect, in the cell-planning method, a case where light or an optical signal is lost due to a loss occurring when the light or optical signal is incident on objects in an actual situation.

The number I_{M} of intersection points between a virtual light ray and the surfaces of the virtual objects to which the virtual light ray is incident while the virtual light ray is traveling in the virtual space may be calculated by equation 2 below. Herein, the intersection point implies a point in a virtual object's surface at which a virtual light ray is incident.

I_{M}=M+1 (2)

In equation 2, I_{M} represents the number of intersection points at which a virtual light ray is incident on a virtual object's surface, and M represents an integer within a range from 0 to n.

If a first intersection point of a virtual light ray is made, the M is 0. In this case, the number I₀ of intersection points is calculated to have a value of 1. I₁ corresponds to a second intersection point of the virtual light ray, and is calculated to have a value of 2.

The allowable number I_{S} of intersection points may be set according to an actual light source or optical transmitter to be used, disposition of virtual objects within a virtual space, and a state of an actual light receiver.

As a result, step (d), i.e. steps 241 and 242, is performed to exclude a light ray which has lost its application in optical communication due to a loss occurring while the light ray is incident on objects.

When the number I_{N} of intersection points of the virtual light ray exceeds the allowable number I_{S} of intersection points in step (d), i.e. in steps 241 and 242, the results of simulation for the virtual light ray, which is in the process of simulation, are stored.

Also, in step 260 of comparing the sequence number L_{N} of the virtual light ray, the simulation results of which have been stored, with the set number L_{S} of virtual light rays, steps (c) to (f), i.e. steps 230, 241, 242, 250, and 260, are repeated when the sequence number L_{N} of the virtual light ray is less than the set number L_{S} of virtual light rays, and the procedure shown in FIG. 2A is terminated when the sequence number L_{N} of the virtual light ray is equal to or greater than the set number L_{S} of virtual light rays, i.e. in the case of “NO” in step 260 of FIG. 2A. Step (f), i.e. step 260, is performed to minimize a simulation time period for virtual light rays, and to terminate the procedure of FIG. 2A. In a case where the set number L_{S} of virtual light rays is 100, the process of FIG. 2A is terminated when an 101^{st} virtual light ray “L₁₀₀” progresses.

FIG. 2B is a flowchart illustrating a procedure for tracing a path of a virtual light ray within the virtual space when the number I_{N} of intersection points of a corresponding virtual light ray is less than the allowable number I_{S} of intersection points in step (d), including steps 241 and 242, (i.e. in the case of “YES” in step 242 of FIG. 2A), as indicated by reference character \textcircled{c}.

That is, when the number IN of intersection points of the virtual light ray is less than the allowable number I_{S} of intersection points in step (d), i.e. in step 242, step 271 of determining if the virtual object's surface having an intersection point with the virtual light ray can be transmitted by the virtual light ray is performed. When it is determined that the virtual object's surface can be transmitted by the virtual light ray, a random number is generated in step 272, then the random number is compared with the transmissivity of the virtual object on which the virtual light ray is incident in step 273. In contrast, when it is determined that the virtual object's surface cannot be transmitted by the incident virtual light ray, i.e. in the case of “NO” in step 271 of FIG. 2B, step 272 of generating a random number and step 273 of comparing the generated random number with the transmissivity may be omitted.

Step 272 of generating a random number and step 273 of comparing the generated random number with the transmissivity may be performed on the assumption that any random number within a range from 0 to 1 may be generated with the same probability. In the case where a random number is 0.5, when the transmissivity of a virtual object on which a virtual light ray is incident is equal to or greater than the random number of 0.5, it may be determined that the virtual object positioned on a light path can be transmitted. In contrast, when the transmissivity of a virtual object on which a virtual light ray is incident is less than the random number of 0.5, it is determined that the corresponding virtual object cannot be transmitted.

When a random number is greater than the transmissivity of a virtual object having an intersection point with a virtual light ray, i.e. in the case of “NO” in step 273 of FIG. 2B, it is determined if the virtual light ray is specularly-reflected from the virtual object's surface in step 274. In contrast, when the random number is equal to or less than the transmissivity of the virtual object, i.e. in the case of “YES” in step 273 of FIG. 2B, the transmission direction of the virtual light ray is established in step 277, then step 241 of identifying the number of intersection points of the virtual light ray is performed, as indicated by reference character \textcircled{D}.

The aforementioned specular reflection represents reflection from a surface, such as a mirror, and implies that the incident angle of a light ray is identical to the exit angle thereof. When the virtual light ray is specularly-reflected (i.e. YES), a reflection algorithm and a reflection direction are established according to the specular reflection of the virtual light ray in step 278, then step 241 of identifying the number of intersection points of the virtual light ray is performed, as indicated by reference character \textcircled{D}.

In contrast, when the virtual light ray is not specularly-reflected (i.e. NO), it is determined if the virtual light ray is irregularly-reflected from the virtual object's surface on which the virtual light ray is incident in step 275. The irregular reflection may occur from an object the surface of which is uniformly constructed by fine particles, such as those of plaster.

When the virtual light ray is irregularly-reflected (i.e. YES), a Lambertian algorithm and directions for the virtual light ray, which is incident on the virtual object's surface, are established in step 279, and then step 241 of identifying the number of intersection points of the virtual light ray is performed, as indicated by reference character \textcircled{D}.

In contrast, when the virtual light ray is not irregularly-reflected (i.e. NO), the direction of the virtual light ray is established according to a Bidirectional Reflectance Distribution Function (BRDF), then step 241 of identifying the number of intersection points of the virtual light ray is performed, as indicated by reference character \textcircled{D}. Herein, the application of the BRDF application implies that a virtual light ray is incident on a virtual object's surface, which is not as smooth as a mirror, but smoother than object surfaces causing irregular reflection, such as plaster.

The state of each virtual object's surface may utilize information provided while a virtual space is implemented, or may be determined according to the characteristics of material constituting the virtual object.

In step 220 of disposing the virtual light source within the virtual space, data about virtual light rays, stored in step 250, may be used to adjust the disposition of the virtual light source. FIG. 2C is a flowchart explaining a change of the settings of virtual light sources.

Referring to FIG. 2C, the process of changing the settings of virtual light sources includes: (o) disposing virtual optical receivers at positions, corresponding to those of actual optical receivers, within the virtual space, and calculating the reception characteristics of the virtual optical receivers by using the path data of virtual light rays, which has been stored in step (f), i.e. in step 250 (step 310); (p) determining if the settings of the virtual light sources are to be changed (step 320); (q) determining if the positions and the number of the virtual light sources are to be changed when it is determined that the settings for the virtual light sources are to be changed (step 330), changing the positions and the number of the virtual light sources when it is determined that the number of the virtual light sources is to be changed (step 370), and then returning to step (b); and (r) determining if the fields of view (FOVS) of virtual light sources are to be changed when it is determined that the settings for the virtual light sources are not to be changed (step 330), adjusting the FOVs of virtual light sources when it is determined that the FOVs of virtual light sources are to be changed (step 360), and then returning to step (b).

When it is determined in step (r), i.e. in step 350, that the FOVs of the virtual light sources are not to be changed (i.e. NO), the procedure of changing the settings of the virtual light sources in FIG. 2C is terminated.

Step (o), i.e. step 310, targets an object or an area on which a virtual optical receiver is to be actually installed, but may target a plurality of positions within the virtual space according to necessity of the designer.

Step (o), i.e. step 310, is performed to determine the intensity of each virtual light ray converged on the virtual optical receivers from the stored path data of virtual light rays, wherein a power mean, power variance, a power CDF, a mean excess delay, an RMS delay, and a maximum excess delay are calculated by taking into consideration the characteristics (i.e. fields of view) of actual optical receivers, sensitivities according to wavelengths, and reception patterns with respect to the intensity of each determined virtual light ray, and are then provided to the user.

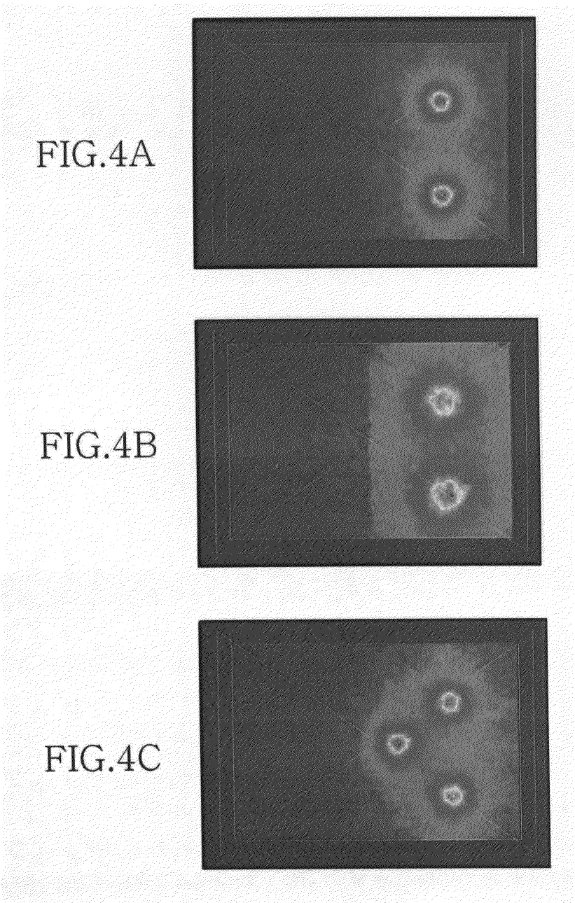

FIGS. 4A to 4C are views illustrating receivable ranges of virtual optical receivers, wherein the receivable ranges are shown as a light-and-darkness distribution state according to the positions of virtual light sources.

When it has been determined that the settings of the virtual light sources are to be changed, step (q) of determining if the number and the positions of the virtual light sources are to be changed is performed, wherein the number and the positions of the virtual light sources may be determined by equation 3 below. When a shadow area occurs with respect to a virtual optical receiver, the number and the positions of the virtual light sources may be determined to be changed. That is, when a shadow occurs at the position of a virtual optical receiver, the step of changing the position of the virtual optical source may be performed to remove the shadow.

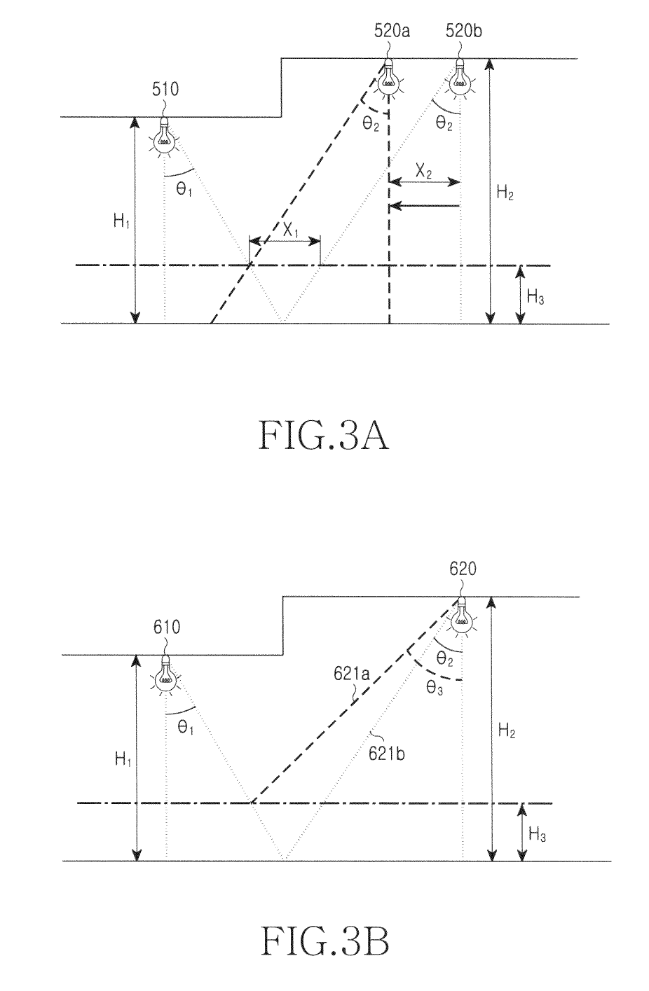

FIG. 3A is a view illustrating the relationship between virtual light rays and the positions and heights of the virtual light sources in order to explain equation 3, wherein two virtual light sources 510 and 510b are illustrated. In detail, FIG. 3A shows a state where the position of one virtual light source 520b between the two virtual light sources is adjusted to a position indicated by reference numeral 520a in order to remove a shadow area X₁ occurring within height H₃, in which the user may be active.

X₁=H₃ tan θ₁+H₃ tan θ₂ (3)

In equation 3, X₁ represents a shadow area (i.e. a movement distance of the position of a virtual light ray), H₁ and H₂ represent heights at which virtual light sources are installed, respectively, and θ₁ and θ₂ represent the FOVs of the virtual light sources, respectively.

FIG. 4B is a view illustrating an image screen after the FOVs are modified, and FIG. 3B is a view explaining the adjustment of an FOV. The adjustment of the FOV of the virtual light sources, as shown in FIG. 4B and FIG. 3B, may be determined by equation 4 below.

$${θ}_{3} = {tan}^{- 1} ( \frac{tan {θ}_{2} {H}_{2} + tan {θ}_{1} {H}_{3}}{{H}_{2} - {H}_{3}} ) \qquad ( 4 )$$

In equation 4, θ₁ represents an FOV of a virtual light source 610 which has no change in the set FOV thereof, θ₂ represents an FOV of a virtual light source 620, which is to have a change in the set FOV thereof, before the FOV of the virtual light source 620 is adjusted, and θ₃ represents an adjusted FOV of the virtual light source 620.

FIG. 3B is a view explaining a state where two virtual light sources 610 and 620 are set. In detail, FIG. 3B illustrates a state where the FOV of one virtual light source 620 between two virtual light sources 610 and 620 is adjusted from reference numeral 621b to 621a, i.e. from θ₂ to θ₃.

When the positions or the number of virtual light sources has been changed or when the FOV of a virtual light source has been adjusted in steps (p) and (q), the procedure may return to step (b).

That is, the procedure shown in FIG. 2C is started by using data of virtual light rays, which is stored in step (e), i.e. in step 250, of storing the virtual light ray when the number of intersection points of the virtual light ray is greater than the allowable number of intersection points, as indicated by reference character “A.” In addition, when the settings for the virtual light sources have been terminated, the procedure of FIG. 2C may return to step 220 of setting virtual light sources in order to apply the changed results, as indicated by reference character “B.”

As seen above, the teachings of the present invention enables simulation for the cell planning, which can be applied even to the construction of a wireless optical communication system using visible light having a large difference in frequency bandwidth.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. A cell-planning method for a wireless optical communication system, the method comprising:
(a) disposing a virtual light source and virtual objects within the virtual space, defining the wireless optical communication system;
(b) checking a sequence number of a virtual light ray generated by the virtual light source;
(c) checking the number of intersection points occurring between the virtual light ray, the checked sequence number, and surfaces of the virtual objects, and comparing the number of intersection points of the virtual light ray with an allowable number of intersection points;
(d) storing the virtual light ray when the number of intersection points of the virtual light ray is greater than the allowable number of intersection points; and
(e) comparing the sequence number of the virtual light ray with a set number of virtual light rays, and repeating steps (b) to (e) when the sequence number of the virtual light ray is less than the set number of virtual light rays.

2. The method as claimed in claim 1, further comprising, when it is determined in step (c) that the number of intersection points of the virtual light ray is less than the allowable number of intersection points:
(f) determining if a virtual object's surface on which an intersection point is made by the virtual light ray can be transmitted by the virtual light ray;
(g) generating a random number when the virtual object's surface can be transmitted, and comparing the random number with transmissivity;
(h) determining if the virtual light ray is specularly-reflected from the virtual object's surface when the random number is greater than the transmissivity; and
(i) determining if the virtual light ray is irregularly-reflected from the virtual object's surface on which the virtual light ray is incident when it is determined in step (h) that the virtual light ray is not specularly-reflected,
wherein, when it is determined in step (f) that the virtual light ray cannot transmit the virtual object's surface, on which an intersection point is made, step (h) is performed.

3. The method as claimed in claim 1, further comprising:
(j) setting a transmitting direction of the virtual light ray, which is incident on the virtual object's surface when the random number is less than the transmissivity in step (g);
(k) setting a reflection algorithm and a reflection direction of the virtual light ray with respect to the virtual object's surface when it is determined in step (h) that the virtual light ray is specularly-reflected from the virtual object's surface; and
(l) setting a reflection direction of the virtual light ray according to a Bidirectional Reflectance Distribution Function (BRDF) when the virtual light ray is not irregularly-reflected from the virtual object's surface on which the virtual light ray is incident in step (i).

4. The method as claimed in claim 1, further comprising:
(n) disposing a virtual optical receiver at a position, corresponding to a position where an optical receiver is to be actually placed, within the virtual space, and calculating a reception characteristic of the virtual optical receiver by using path data of the virtual light ray, which has been stored in step (e);
(o) determining if a setting for the virtual light source is to be changed, based on the calculated reception characteristic of the virtual optical receiver;
(p) determining if the number and positions of virtual light sources are to be changed when the setting for the virtual light source is to be changed, changing the number and positions of the virtual light sources when it is determined that the number and the positions of the virtual light sources are to be changed, and then applying a result of the change to step (a); and
(q) determining if a field of view (FOV) of the virtual light source is to be changed when the number and positions of virtual light sources are not to be changed, adjusting the FOV of the virtual light source when it is determined that the FOV is to be changed, and then applying a result of the adjustment to step (a).

5. The method as claimed in claim 1, wherein step (b) satisfies an equation,
L_{N}=N+1,
wherein L represents a virtual light ray, and N represents a sequence number of the virtual light ray and has a value within a range from 0 to n.

6. The method as claimed in claim 1, wherein step (c) satisfies an equation,
I_{M}=M+1,
wherein I_{M} represents the number of intersection points generated between a path of a virtual light ray and surfaces of virtual objects, and M is a value within a range from 0 to n.

7. The method as claimed in claim 4, wherein a position of the virtual light source is determined based on an equation,
X₁=H₃ tan θ₁+H₃ tan θ₂,
wherein X₁ represents a movement distance of a virtual light source, H₁ and H₂ represent heights at which virtual light sources are installed, respectively, and θ₁ and θ₂ represent FOVs of virtual light sources, respectively.

8. The method as claimed in claim 4, wherein the FOV of the virtual light source is determined based on an equation,
$${θ}_{3} = {tan}^{- 1} ( \frac{tan {θ}_{2} {H}_{2} + tan {θ}_{1} {H}_{3}}{{H}_{2} - {H}_{3}} ) ,$$
wherein θ₁ represents an FOV of a virtual light source which has no change in a set FOV thereof, θ₂ represents an FOV of a virtual light source, which is to have a change in a set FOV thereof, before the FOV of the virtual light source is adjusted, and θ₃ represents an adjusted FOV.
